(19) United States
(12) Patent Application Publication
(10) Pub. No.: US 2008/0212311 A1
(43) Pub. Date: Sep. 4, 2008

(54) Portable Lighting System

(75) Inventor: Terry J. Peterson, Dammeron Valley, UT (US)

Correspondence Address: FISH & RICHARDSON PC, P.O. BOX 1022, MINNEAPOLIS, MN, 55440-1022, US

(73) Assignee: HYBRID LIGHT, St. George, UT (US)

(21) Appl. No.: 11/680,923

(22) Filed: Mar. 1, 2007

(51) Int. Cl. F21V 21/084; F21V 21/00; F21L 4/00

(52) U.S. Cl. 362/106; 362/191; 362/382

(57) ABSTRACT

A portable lighting system including a light housing carrying at least one light emitter and a power source powering at least one light emitter. At least one portion of an interface is disposed on the light housing for securing an attachment having a corresponding mating portion of the interface. The interface includes a male portion having multiple protrusions and a female portion configured to receive and releasably retain the corresponding protrusions of the male portion. In another aspect, the interface for releasably secures a fastener to an attachment. At least one portion of the interface is disposed on the attachment and at least one mating portion of the interface is disposed on the fastener.

### TECHNICAL FIELD

This disclosure relates to portable lighting systems.

### BACKGROUND

Portable lighting systems are used to illuminate an area. There are numerous portable lighting systems having a body and a mounting device or other attachment secured to the body. The body generally includes a light for illuminating an adjacent area. Typically, the mounting device or other attachment is secured to the body by screw fasteners, adhesives, or as an integral extension of the body. Examples of portable lighting systems include flashlights, head lights, lanterns, and clip-on lights.

### SUMMARY

In one aspect, a portable lighting system includes a light housing carrying at least one light emitter and a power source powering at least one light emitter. At least one portion of an interface is disposed on the light housing for securing an attachment having a corresponding mating portion of the interface. The interface includes a male portion having multiple protrusions and a female portion configured to receive and releasably retain the corresponding protrusions of the male portion.

In another aspect, a portable lighting system includes a light housing carrying at least one light emitter and a power source powering at least one light emitter. At least one portion of an interface is disposed on the light housing for securing an attachment having a corresponding mating portion of the interface. The interface includes a first portion having a magnetic surface and a second portion having a magnetically attractable surface.

In yet another aspect, an interface for releasably securing an attachment to a hat visor lighting system includes a male portion having multiple protrusions and a female configured to receive and releasably retain the corresponding protrusions of the male portion. At least one portion of the interface is disposed on the attachment and at least one mating portion of the interface is disposed on the light system.

In yet another aspect, an interface for releasably securing a fastener to an attachment includes a male portion having multiple protrusions and a female configured to receive and releasably retain the corresponding protrusions of the male portion. At least one portion of the interface is disposed on the attachment and at least one mating portion of the interface is disposed on the fastener.

Implementations of the disclosure may include one or more of the following features. In some examples, the male portion of the interface is disposed on the light housing and the female portion of the interface is disposed on the attachment. In other examples, the male portion of the interface is disposed on the attachment and the female portion of the interface is disposed on the light housing. The male and female portions of the interface may be substantially arched. In some instances, the male interface portion defines a substantially convex shape and the female interface portion defines a substantially concave shape. The protrusions are substantially cylindrical, but may have other profiles (e.g. square, conical, etc.). The male portion of the interface may have sixteen protrusions spaced equidistantly.

In some implementations, the attachment is a fastener, such as a clip. The attachment may also be another portable lighting system or an optical device, such as a magnifier or mirror.

In another aspect, a hat visor lighting system includes a light housing having upper and lower surfaces. The light housing carries at least one light emitter and a power source powering at least one light emitter. The lighting system includes a fastener (e.g. a clip) having upper and lower surfaces and an interface. The interface includes a male portion having multiple protrusions and a female portion configured to receive and releasably retain the corresponding protrusions of the male portion. At least one portion of the interface is disposed on at least one of the upper and lower surfaces of the light housing and at least one corresponding mating portion of the interface is disposed on at least one of the upper and lower surfaces of the fastener. The fastener is releasably securable to at least one of the upper and lower surfaces of the light housing.

Implementations of this aspect may include one or more of the following features. In some examples, the male portion of the interface is disposed on the upper surface of the light housing and the female portion of the interface is disposed on the lower surface of the fastener. In other examples, the male portion of the interface is disposed on the upper surface of the fastener and the female portion of the interface is disposed on the lower surface of the light housing. The male and female portions of the interface may be substantially arched. In some instances, the male interface portion defines a substantially convex shape and the female interface portion defines a substantially concave shape. The protrusions are substantially cylindrical, but may have other profiles (e.g. square, conical, etc.). The male portion of the interface may have sixteen protrusions spaced equidistantly.

In some implementations, the attachment is a fastener, such as a clip. In one example, the fastener includes at least one portion of the interface for securing an attachment having a corresponding mating portion of the interface. The attachment may also be another lighting system or an optical device, such as a magnifier or mirror.

The details of one or more implementations of the disclosure are set fourth in the accompanying drawings and the description below. Other features, objects, and advantages will be apparent from the description and drawings, and from the claims.

### DESCRIPTION OF DRAWINGS

FIG. 1 is a perspective view of a portable lighting system.

FIG. 2 is an exploded view of a portable lighting system.

FIGS. 3-4 are perspective views of a clip with an attachment interface.

FIG. 5 is a front view of a clip with an attachment interface.

FIG. 6 is a bottom view of a clip with an attachment interface.

FIG. 7 is an exploded view of an attachment interface.

FIGS. 8-9 are perspective views of an upper portion of a light housing.

FIG. 10 is a side view of an upper portion of a light housing.

FIG. 11 is a bottom view of an upper portion of a light housing.

FIG. 12 is a top view of an upper portion of a light housing.

FIGS. 13-14 are perspective views of a lower portion of a light housing.

FIG. 15 is a bottom view of a lower portion of a light housing.

FIG. 16 is a top view of a lower portion of a light housing.

FIG. 17 is a perspective view of cover for an upper portion of a light housing.

FIG. 18 is a top view of cover for an upper portion of a light housing.

FIG. 19 is a front view of cover for an upper portion of a light housing.

FIG. 20 is a bottom view of cover for an upper portion of a light housing.

FIG. 21 is a side view of cover for an upper portion of a light housing.

Like reference symbols in the various drawings indicate like elements.

### DETAILED DESCRIPTION

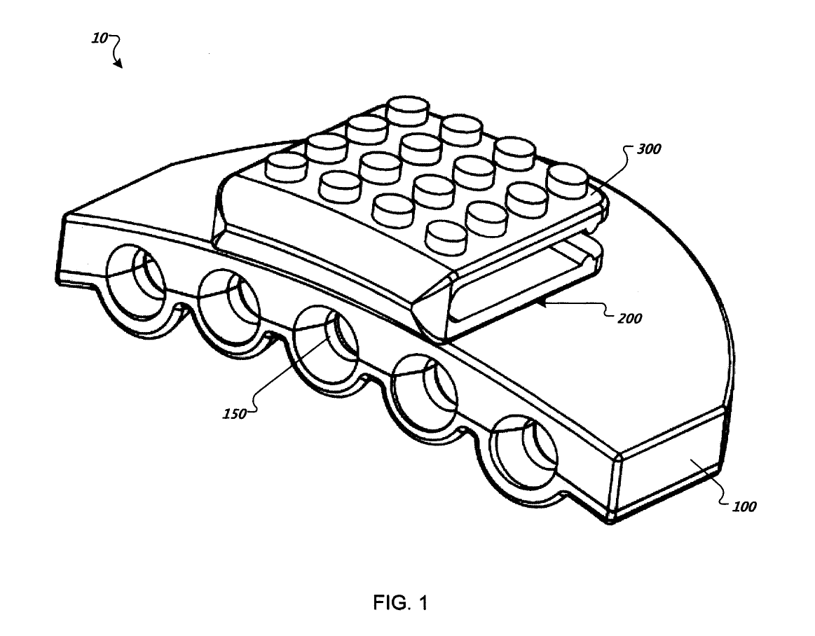

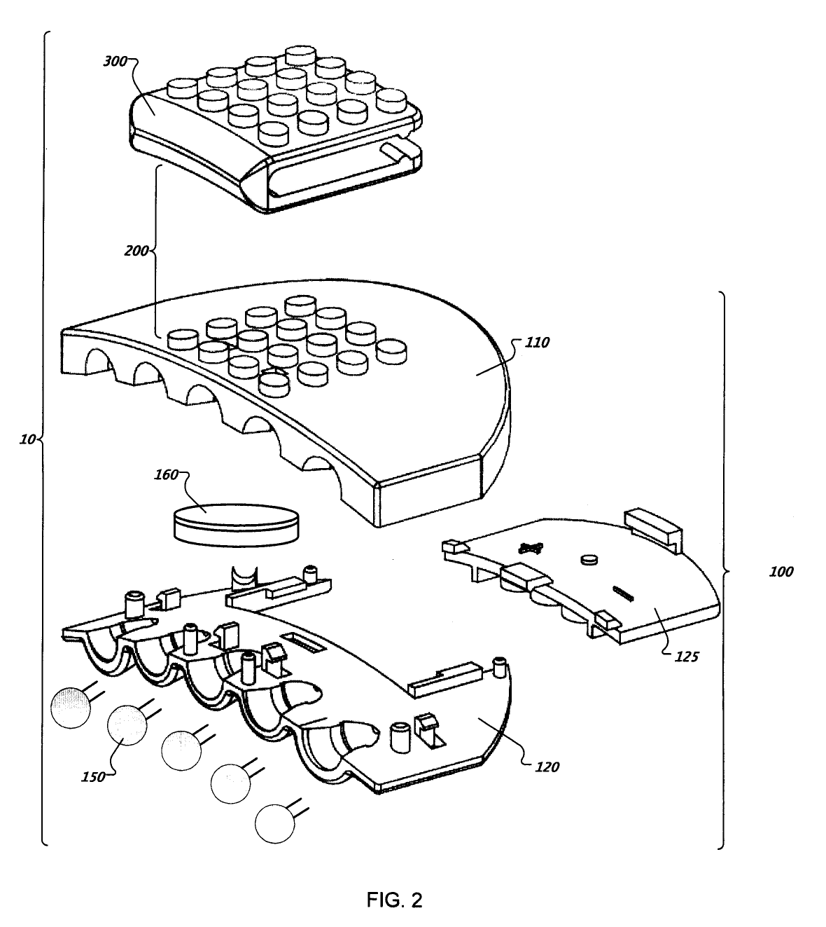

Referring to FIGS. 1-2, a portable lighting system 10 includes a light housing 100 carrying at least one light emitter 150 and a power source 160 powering at least one light emitter. At least one portion 210, 220 of an interface 200 is disposed on the light housing 100 for securing an attachment 300 having a corresponding mating portion 210, 220 of the interface 200.

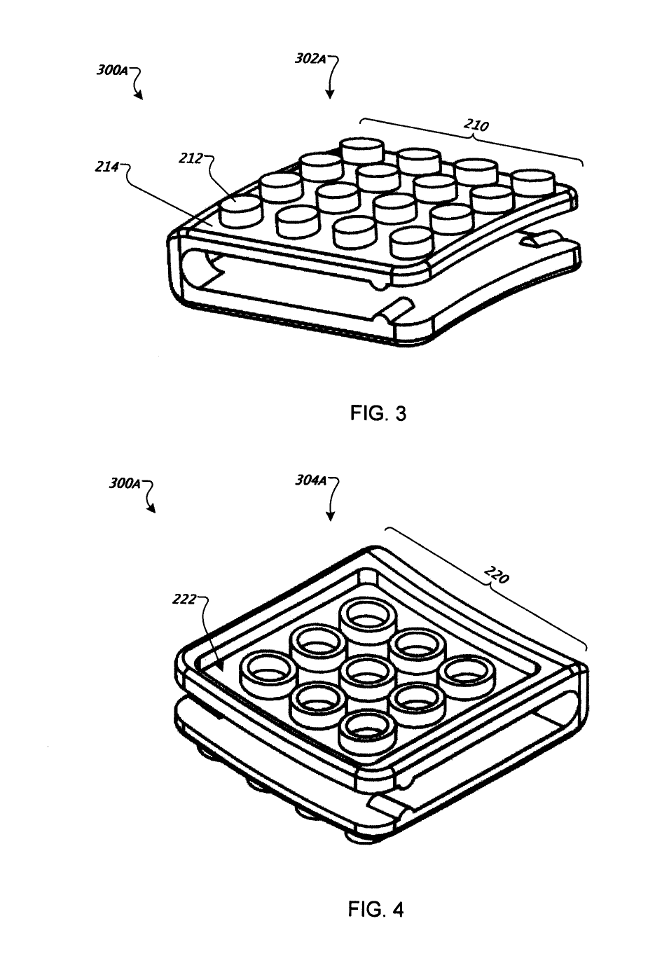

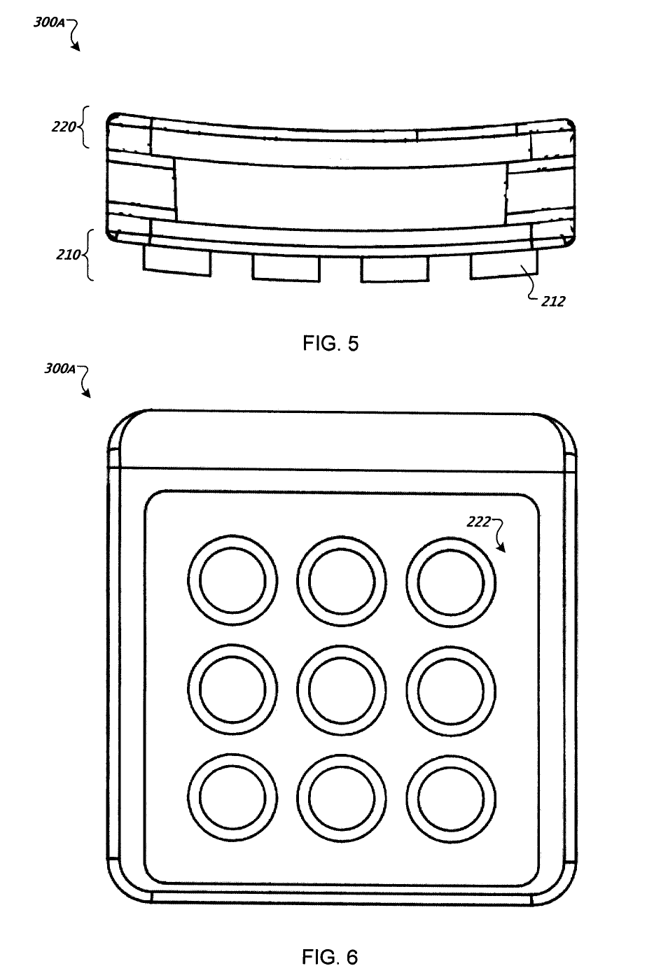

Referring to FIGS. 3-6, the interface 200 for releasably securing an attachment 300 (e.g. a clip 300A) to a light housing 100 includes a male portion 210 having multiple protrusions 212 and a female portion 220 configured to receive and releasably retain the corresponding protrusions 212 of the male portion 210. In some examples, the protrusions 212 extend outwardly normal to a surface 214 of the male portion 210. In one implementation, the female portion 220 defines at least one receptacle 222 configured to receive and releasably retain the corresponding protrusions 212. At least one portion of the interface is disposed on the attachment and at least one corresponding mating portion of the interface is disposed on the light system. In some instances, the male portion 210 of the interface 200 is disposed on the light housing 100 and the female portion 220 of the interface 200 is disposed on the attachment 300. In other instances, the male portion 210 of the interface 200 is disposed on the attachment 300 and the female portion 220 of the interface 200 is disposed on the light housing 100.

In some implementations, the male and female portions 210, 220 of the interface 200 are substantially arched. In one example, the male interface portion 210 defines a substantially convex shape and the female interface portion 220 defines a substantially concave shape. The protrusions, in some implementations, are substantially cylindrical and spaced equidistantly. In one example, the male portion 210 of the interface 200 includes sixteen protrusions 212. However, other numbers of protrusions 212 are possible.

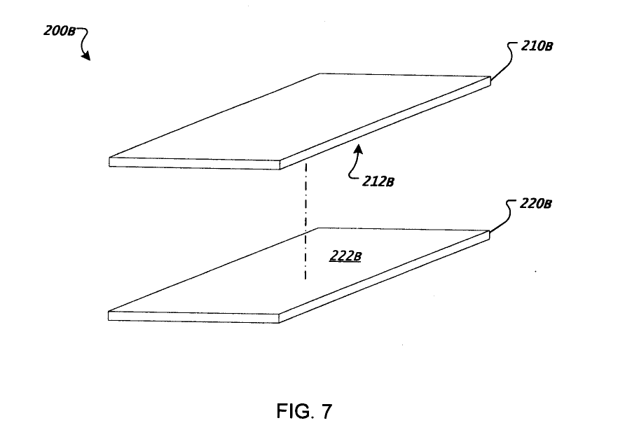

Referring to FIG. 7, in some implementations, an interface 200B includes a first portion 210B having a magnetic surface 212B and a second portion 220B having a magnetically attractable surface 222B.

In some implementations, the attachment 300 is a fastener (e.g. a clip 300A). In other implementations, the attachment 300 is another portable lighting system 10. In yet other implementations, the attachment 300 is an optical device, such as a magnifier or mirror.

The portable lighting system 10 is a hat visor lighting system, in some implementations, where the light housing 100 has upper and lower surfaces 102 and 104, respectively, and the attachment 300 is a clip 300A having upper and lower surfaces 302A and 304A, respectively. At least one portion 210, 220 of the interface 200 is disposed on at least one of the upper and lower surfaces 102 and 104, respectively, of the light housing 100 and at least one corresponding mating portion 210, 220 of the interface 200 is disposed on at least one of the upper and lower surfaces 302A and 304A, respectively, of the clip 300A. The clip 300A is releasably securable to at least one of the upper and lower surfaces 102 and 104, respectively, of the light housing 100. In some examples, the clip 300A includes at least one portion 210, 220 of the interface 200 disposed on at least one of the upper and lower surfaces 302A and 304A, respectively, to secure another attachment having at least one corresponding mating portion 210, 220 of the interface 200. The attachment may include an optical device, another lighting system 10, etc.

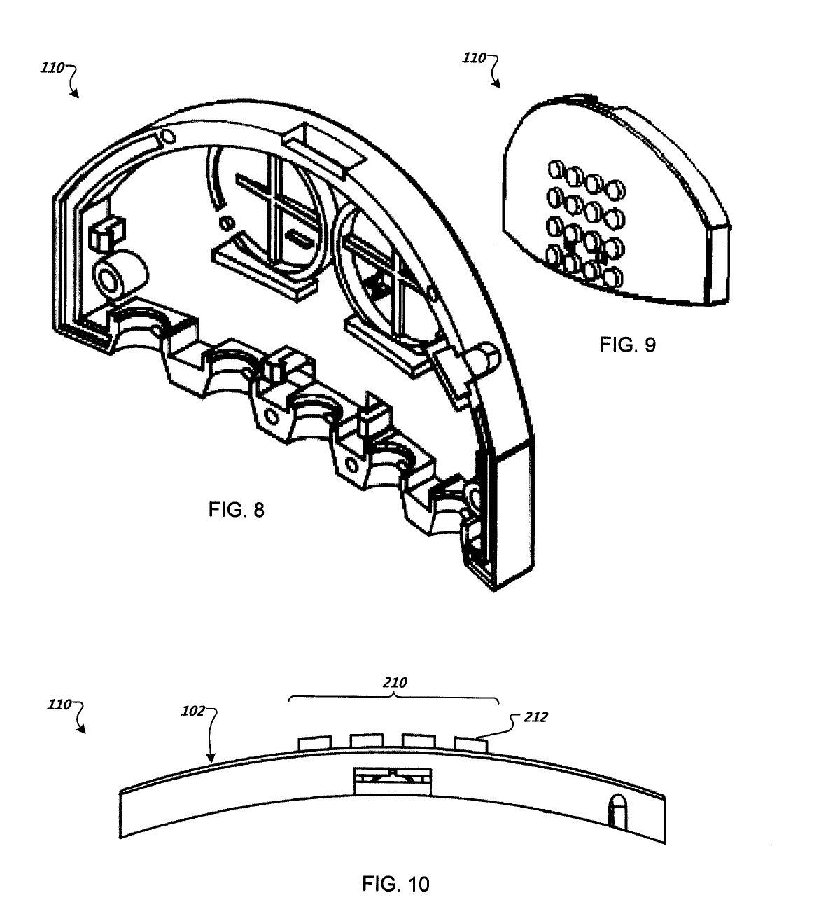

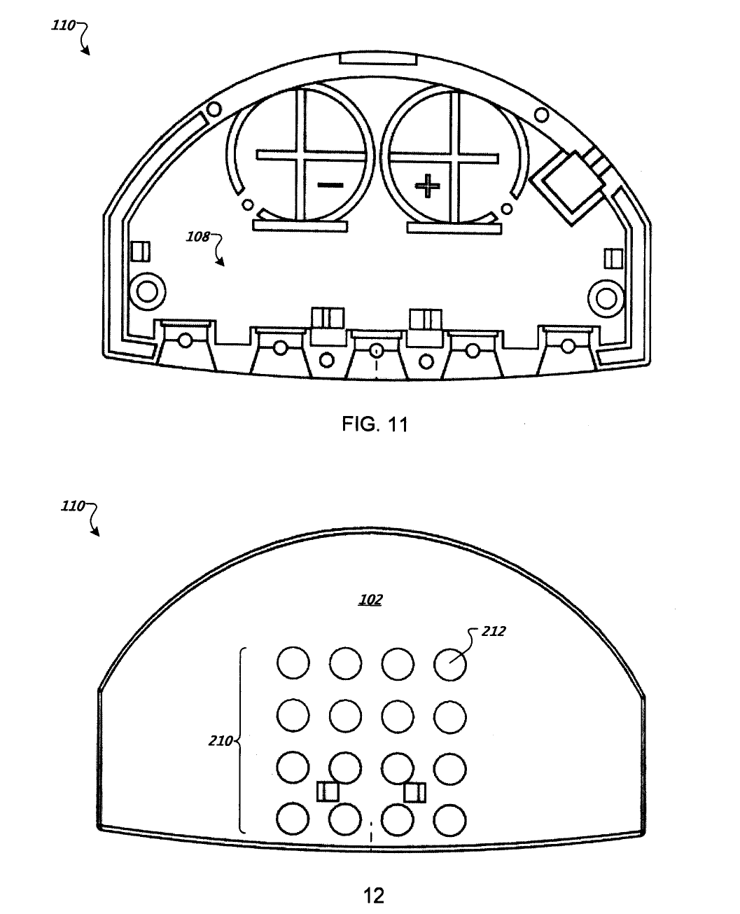

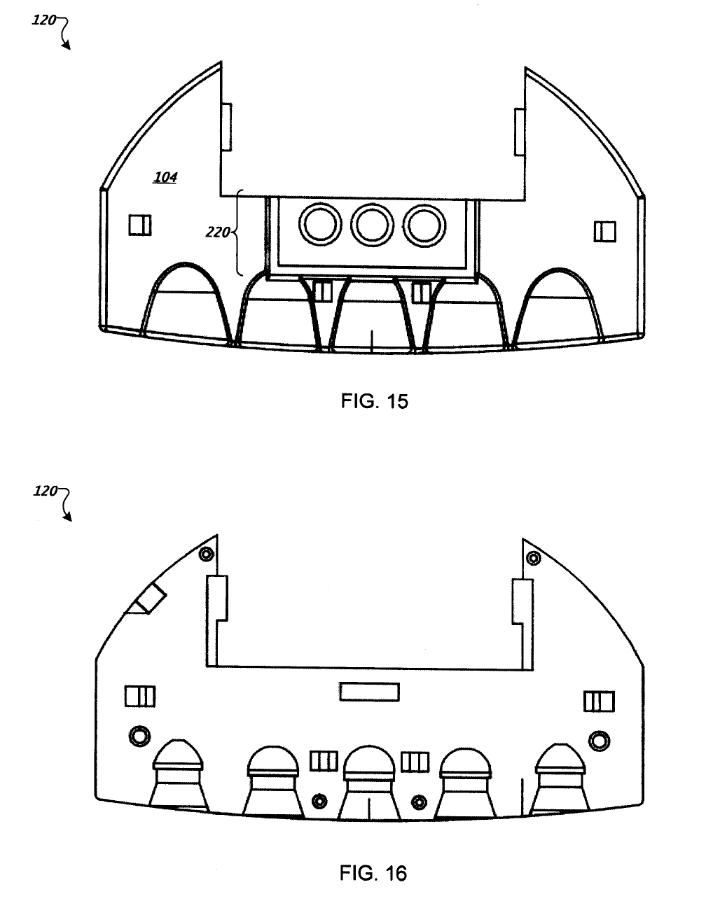

Referring to FIGS. 8-16, in some implementations, the light housing 100 includes upper and lower portions 110 and 120, respectively. The upper portion 110 of the light housing 100 has upper surface 102 and the lower portion 110 of the light housing 100 has lower surface 104.

Referring to FIGS. 8-12, the upper portion 110 of the light housing 100 defines at least one cavity 108 to receive and carry at least one light emitter 150 and the power source 160 (e.g. a battery). In one implementation, the upper portion 110 of the light housing 100 carries five light emitters 150. The upper portion 110 of the light housing 100 defines an arched shape, as shown in FIG. 10. In some instances, the upper portion 110 of the light housing 100 defines a convex shape. In the example shown, the male portion 210 of the interface 200 is disposed on the upper portion 110 of the light housing 100 and has sixteen protrusions 212 normal to the curved surface 102. In other examples, the female portion 220 of the interface 200 is disposed on the upper portion 110 of the light housing 100. In one example, a combination of both portions 210, 220 of the interface 200 is disposed on the upper portion 110 of the light housing 100.

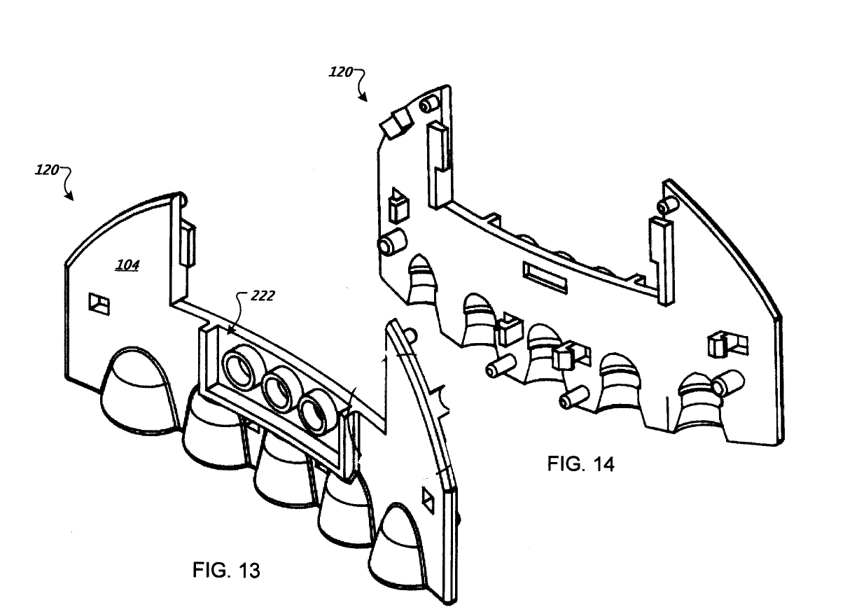

Referring to FIGS. 13-16, the lower portion 120 of the light housing 100 is joined to the upper portion 110 of the light housing 100 to cover at least one cavity 108, for example, to retain at least one light emitter 150 or the power source 160. The lower portion 120 of the light housing 100 defines an arched shape, as shown in FIGS. 13-14. In some instances, the lower portion 120 of the light housing 100 defines a concave shape. In the example shown, the female portion 220 of the interface 200 is disposed on the lower portion 120 of the light housing 100 and defines a receptacle configured to receive and releasably retain the protrusions 212. In other examples, the male portion 210 of the interface 200 is disposed on the lower portion 120 of the light housing 100. In one example, a combination of both portions 210, 220 of the interface 200 is disposed on the lower portion 120 of the light housing 100.

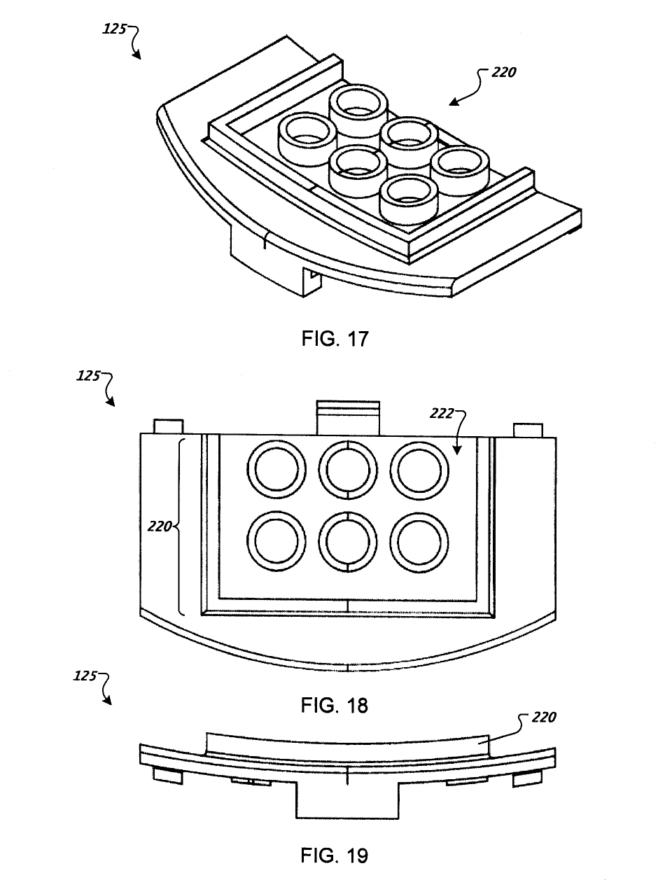

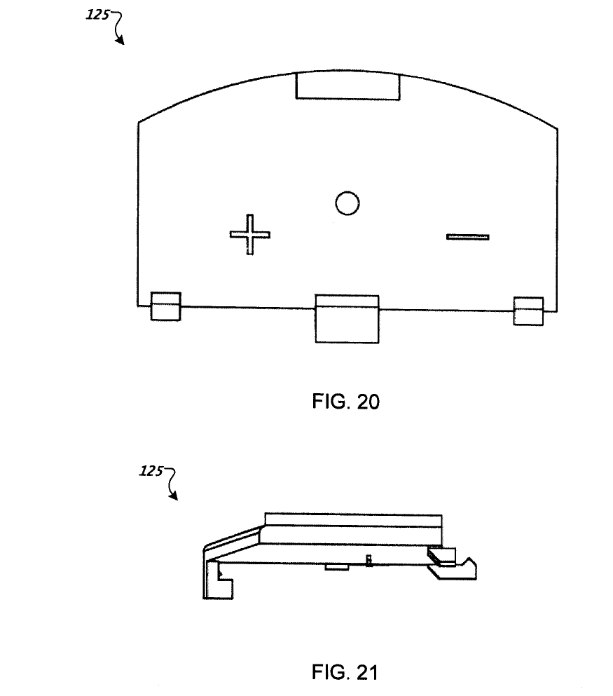

Referring to FIGS. 17-21, in some implementations, the lower portion 120 of the light housing 100 includes a cavity cover 125 removable from the light housing 100 to facilitate easy servicing of least one light emitter 150 or the power source 160. In the example shown, the cover 125 includes a segment of the female portion 220 of the interface 200.

1. A portable lighting system comprising:
a light housing;
at least one light emitter carried by the light housing;
a power source carried by the light housing and powering at least one light emitter; and
at least one portion of an interface disposed on the light housing for securing an attachment having a corresponding mating portion of the interface, the interface comprising:
a male portion having multiple protrusions; and
a female portion configured to receive and releasably retain the corresponding protrusions of the male portion.

2-3. (canceled)

4. The portable lighting system of claim 1 wherein the male and female portions of the interface are substantially arched.

5. The portable lighting system of claim 1 wherein the male interface portion defines a substantially convex shape and the female interface portion defines a substantially concave shape.

6-10. (canceled)

11. The portable lighting system of claim 1 wherein the attachment comprises a clip.

12. The portable lighting system of claim 1 wherein the attachment comprises another portable lighting system.

13-15. (canceled)

16. A hat visor lighting system comprising:
a light housing having upper and lower surfaces;
at least one light emitter carried by the light housing;
a power source carried by the light housing and powering at least one light emitter;
a fastener having upper and lower surfaces; and
an interface comprising:
a male portion having multiple protrusions; and
a female portion configured to receive and releasably retain the corresponding protrusions of the male portion;
wherein at least one portion of the interface is disposed on at least one of the upper and lower surfaces of the light housing and at least one corresponding mating portion of the interface is disposed on at least one of the upper and lower surfaces of the fastener, the fastener being releasably securable to at least one of the upper and lower surfaces of the light housing.

17-22. (canceled)

23. The hat visor lighting system of claim 16 wherein the male and female portions of the interface are substantially arched.

24. The hat visor lighting system of claim 16 wherein the male interface portion defines a substantially convex shape and the female interface portion defines a substantially concave shape.

25-27. (canceled)

28. The hat visor lighting system of claim 16 wherein the fastener comprises a clip.

29. The hat visor lighting system of claim 16 wherein at least one portion of the interface is disposed on the fastener for securing an attachment having a corresponding mating portion of the interface.

30-33. (canceled)

34. A portable lighting system comprising:
a light housing;
at least one light emitter carried by the light housing;
a power source carried by the light housing and powering at least one light emitter; and
at least one portion of an interface disposed on the light housing for securing an attachment having a corresponding mating portion of the interface, the interface comprising:
a first portion having a magnetic surface; and
a second portion having a magnetically attractable surface.

35-36. (canceled)

37. The portable lighting system of claim 34 wherein the male and female portions of the interface are substantially arched.

38. The portable lighting system of claim 34 wherein the male interface portion defines a substantially convex shape and the female interface portion defines a substantially concave shape.

39. (canceled)

40. The portable lighting system of claim 34 wherein the attachment comprises a clip.

41. The portable lighting system of claim 34 wherein the attachment comprises another portable lighting system.

42-44. (canceled)

45. An interface for releasably securing an attachment to a hat visor lighting system, the interface comprising:
a male portion having multiple protrusions; and
a female portion configured to receive and releasably retain the corresponding protrusions of the male portion;
wherein at least one portion of the interface is disposed on the attachment and at least one mating portion of the interface is disposed on the light system.

46. The interface of claim 45 wherein the male and female portions of the interface are substantially arched.

47. The interface of claim 45 wherein the male interface portion defines a substantially convex shape and the female interface portion defines a substantially concave shape.

48-53. (canceled)

54. The interface of claim 45 wherein the attachment comprises a clip.

55. The interface of claim 45 wherein the attachment comprises another lighting system.

56-58. (canceled)

59. An interface for releasably securing an attachment to a fastener, the interface comprising:
a male portion having multiple protrusions; and
a female portion configured to receive and releasably retain the corresponding protrusions of the male portion;
wherein at least one portion of the interface is disposed on the attachment and at least one mating portion of the interface is disposed on the fastener.

60. The interface of claim 59 wherein the male and female portions of the interface are substantially arched.

61. The interface of claim 59 wherein the male interface portion defines a substantially convex shape and the female interface portion defines a substantially concave shape.

62-66. (canceled)

67. The interface of claim 59 wherein the attachment comprises a lighting system.

68-70. (canceled)

71. The interface of claim 59 wherein the fastener comprises a clip.
